(19) United States
(12) Patent Application Publication
(10) Pub. No.: US 2021/0268595 A1
(43) Pub. Date: Sep. 2, 2021

(54) SYSTEMS AND METHODS FOR REMOTE COMMUNICATION OF CONTROL AND DIAGNOSTICS DATA IN A WELDING SYSTEM

(71) Applicant: Illinois Tool Works Inc., Glenview, IL (US)

(72) Inventor: Jeffery R. Ihde, Greenville, WI (US)

(21) Appl. No.: 17/160,512

(22) Filed: Jan. 28, 2021

Related U.S. Application Data
(60) Provisional application No. 62/983,299, filed on Feb. 28, 2020.

(51) Int. Cl. B23K 9/095; B23K 9/10

(52) U.S. Cl. CPC B23K 9/0953; B23K 9/1062; B23K 9/1087

(57) ABSTRACT

Systems and methods for monitoring and/or controlling a welding system using a remote device are disclosed. The remote device communicates, via one or more transceivers or communication circuits, with one or more component of the welding system (such as a welding power supply or auxiliary device) or a remote computing system (such as a personal computer, cloud computing resource, etc.). The remote device receives signals from the welding system, the signals containing data associated with diagnostic parameters of one or more of the components. The remote device then controls one or more transceivers to transmit signals containing the data to the remote computing system. There, the data may be analyzed, manipulated, and/or displayed. In some examples, software update data is provided to the remote device and transmitted to a welding system component associated with the particular software update.

### CROSS-REFERENCE TO RELATED APPLICATIONS

This application hereby claims priority to and the benefit of U.S. Provisional Application Ser. No. 62/983,299, entitled “SYSTEMS AND METHODS FOR REMOTE COMMUNICATION OF CONTROL AND DIAGNOSTICS DATA IN A WELDING SYSTEM,” filed Feb. 28, 2020, which is hereby incorporated by reference in its entirety for all purposes.

### BACKGROUND

Conventionally, industrial systems utilized integrated control and diagnostic systems. For example, a control panel can be located with a welding system (such as an engine-driven power system) to provide access to controls and information at the system's location. If an operator wishes to access the system's information, however, coordinating communication with remote systems can be challenging. It is therefore desirable to employ systems and methods that address the issues associated with remote access to such system.

### SUMMARY

Systems and methods for remote communication of control and diagnostics data in a welding system are disclosed, substantially as illustrated by and described in connection with at least one of the figures.

### BRIEF DESCRIPTION OF THE DRAWINGS

FIG. 1 is a schematic diagram of an example welding system and remote device, in accordance with aspects of this disclosure.

FIG. 2A is a schematic diagram of another example welding system, in accordance with aspects of this disclosure.

FIG. 2B is a schematic diagram of yet another example welding system, in accordance with aspects of this disclosure.

FIG. 2C is a schematic diagram of yet another example welding system, in accordance with aspects of this disclosure.

FIG. 3A is an illustration of an example remote device, in accordance with aspects of this disclosure.

FIG. 3B is an illustration of an example display of a remote device, in accordance with aspects of this disclosure.

FIG. 4 is a flowchart representative of an example method for remote communication of control and diagnostics data in a welding system, in accordance with aspects of this disclosure.

FIG. 5 is a flowchart representative of another example method for remote communication of control and diagnostics data in a welding system, in accordance with aspects of this disclosure.

The figures are not necessarily to scale. Where appropriate, similar or identical reference numbers are used to refer to similar or identical components.

### DETAILED DESCRIPTION

Disclosed are systems and methods for monitoring and/or controlling a welding system using a remote device. In some examples, the remote device is configured to communicate, via one or more transceivers or communication circuits, with one or more component of the welding system (such as a welding power supply or auxiliary device) or a remote computing system (such as a personal computer, cloud computing resource, etc.). The remote device receives signals from the welding system, the signals containing data associated with diagnostic parameters of one or more of the components. The remote device then controls one or more transceivers to transmit signals containing the data to the remote computing system. There, the data may be analyzed, manipulated, and/or displayed.

In some examples, the remote device is configured to receive software updates for the welding power supply and/or the auxiliary device from the remote computer system, via the one or more transceivers or communication circuits. The remote device receives the signals from the welding system, and identifies the software update as corresponding to the welding power supply or the auxiliary device. The remote device then controls one or more transceivers, via the remote control circuitry, to transmit signals containing the software update to the corresponding welding power supply or auxiliary device. There, the software update may be incorporated into the welding power supply or the auxiliary device's operating system.

As welding power supplies may be located a distance from the work piece or welding operation, access to welding power supply diagnostics is limited. In an example, some welding power supplies are engine driven. Engines are complex, and comprehensive visibility over their diagnostic and runtime information can provide actionable information to an operator, such as an indication that maintenance is required, fuel, etc.

Thus, remote access to diagnostic information from the welding power supply can be valuable to an operator. Conventionally, such information can be accessed from integrated welding power supply circuitry, which may be stored on a memory storage device of the welding power supply. To access the information, a physical media (e.g., a portable a memory device such as a universal serial bus device) is connected to the welding power supply memory storage device to transfer the information. An operator saves the information on the physical media for transfer to a device enabled to view the information, such as a personal computer (PC). However, this process is time consuming, requiring multiple components and physical connections, and cannot be implemented in real-time during a welding operation.

By employing an example remote device as disclose herein, welding system diagnostic information is communicated from one or more components (e.g., the welding power supply, auxiliary device, etc.) to the remote device without the need to physically connect or interface with the welding system (e.g., via a control or front panel of a welding power supply). The diagnostic information can be transferred from the remote device to a remote computing system (e.g., a PC, via a wireless network or a wired port), and/or displayed on the remote device.

In some examples, diagnostic information can be transmitted via one component to another within the welding system. This can be stored on the receiving component for future access, and/or transmitted to another device in communication with the receiving component.

In disclosed examples, the diagnostic information can be transmitted and/or displayed to or through the remote device in real-time. In other words, the operator may view the diagnostic information on the remote device and/or the diagnostic information can be delivered to the remote computing system for analysis, manipulation and/or display during the welding operation. In particular, welding diagnostic information and/or engine related data is available in real-time, which is particularly useful for operators, service centers, etc.

In some examples, the remote device includes a memory storage device, and can collect information from the components of the welding system for future analysis and/or transmission. For example, components of the welding system can include a welding power supply, an engine driven power supply, one or more welding tools (e.g., a welding type torch, plasma cutter, etc.), one or more auxiliary devices (e.g., a wire feeder) or one or more accessories (e.g., an air compressor, a battery charger, etc.).

The signals include data corresponding to one or more diagnostic parameters associated with one or more components of the welding system (e.g., a voltage, a current, a power value, an engine status, a welding process, oil level, temperature, run time, battery status, amount of electrode wire consumed/remaining, software version, etc.). The signals may be generated from the remote device or the welding power supply (e.g., via a remote user interface or a welding user interface, respectively).

In some examples, a user interface of the remote device are updated to reflect (e.g., display) an indicia corresponding to the diagnostic parameter (e.g., a graphic, text, animation, etc., representing the diagnostic parameter).

For at least the reasons provided with respect to the disclosed systems and methods, several advantages are provided. For example, the diagnostic information can be provided as a service file, available to an operator located a distance from the component being serviced. Further, each component can transmit data directly to the remote device (e.g., as commanded at the output and/or by monitoring form one or more sensors). Thus, storage of diagnostic data can be limited or avoided at the component (e.g., the need for a memory storage device is limited). Additionally, the remote device provides the diagnostic information to an operator or serviceperson at their location, in real-time, without the need to physically approach or access the component. Although some examples disclose a dedicated link between a remote device and a single component or power supply, in other examples a single remote device may communicate with multiple components to access diagnostic information from each component. In some examples, a single component may be connected to and accessed by multiple remote devices to provide access to the component's diagnostic information.

Several examples are provided with respect to welding systems, some of which include diesel engines driving one or more of a generator, an air compressor, and/or a welding power supply. However, the concepts and principles disclosed herein are equally applicable to various other industrial environments with distributed components.

In disclosed examples, remote device for monitoring or controlling a welding power supply includes a transceiver configured to receive one or more wireless signals from the welding power supply, wherein the signals include data corresponding to one or more diagnostic parameters associated with the welding power supply. A remote control circuitry is configure to receive the data from the signals from the transceiver, identify a diagnostic parameter of the one or more diagnostic parameters within the data, and control the transceiver to transmit another signal comprising the diagnostic parameter to a remote computer system.

In some examples, a remote user interface is included, the remote control circuitry further to receive diagnostic parameters from the welding power supply or an auxiliary device, and display the diagnostic parameter on one or more regions of the remote user interface.

In some examples, a memory storage device is included, the remote control circuitry is further to store the diagnostic parameters on the memory storage device. In some examples, the remote control circuitry is further configured to transmit data from the memory storage to a remote computing system in real-time.

In some examples, the one or more signals are transmitted via a welding transceiver directly from one or more sensors corresponding to one or more sub-systems of the welding system, the one or more signals including raw data from the one or more sensors.

In some examples, an input port is included to receive a cable to connect to the welding power supply, an auxiliary device, or a remote computer system, the input port to transmit power or information to or receive power or information from the welding power supply, the auxiliary device, or the remote computer system.

In some examples, a rechargeable energy storage device is included, the rechargeable energy storage device being rechargeable by a power output of the welding power supply, the auxiliary device, or the remote computer system.

In some examples, the remote control circuitry is further configured to initiate transfer of data between the remote computer system and the welding power supply at periodic intervals, in response to a user input, or a combination of both.

In some examples, the remote control circuitry is further to transmit information to and receive information from an auxiliary device, receive diagnostic information from the auxiliary device, and display the diagnostic information on one or more regions of a remote user interface.

In some examples, the remote control circuitry is further to receive data from the welding power supply, and transmit the data from the welding power supply to the auxiliary device. In some examples, the remote control circuitry is further to receive commands or data from the auxiliary device, and transmit the commands or data from the auxiliary device to the welding system.

In some examples, the one or more diagnostic parameters comprises one or more of an engine time usage, fuel consumption, temperature, wire consumption, battery charge status, wire feeder roller time usage, contact tip time usage, oil level, or software version.

In disclosed examples, a remote device for monitoring or controlling a welding power supply includes a transceiver configured to receive one or more signals from a remote computer system, wherein the signals include data corresponding to one or more software updates associated with the welding power supply and a remote control circuitry. The remote control circuitry receives the data in the signals from the transceiver, identifies a welding power supply software update of the one or more software updates within the data, and controls the transceiver to transmit a wireless signal comprising the welding power supply software update to the welding power supply.

In some examples, the transceiver further configured to receive one or more signals from the remote computer system that include data corresponding to one or more software updates associated with an auxiliary device. The remote control circuitry is further to receive the data in the signals from the transceiver, identify an auxiliary device software update of the one or more software updates within the data, and control the transceiver to transmit a wireless signal comprising the auxiliary device software update to the auxiliary device.

In some examples, the transceiver is further configured to receive one or more wireless signals from the welding power supply that include data corresponding to one or more software updates associated with an auxiliary device, and wherein the remote control circuitry is further to receive the data in the signals from the transceiver, identify an auxiliary device software update of the one or more software updates within the data, and control the transceiver to transmit a second wireless signal comprising the auxiliary device software update to the auxiliary device.

In some examples, the transceiver further configured to receive one or more wireless signals from an auxiliary device that include data corresponding to one or more software updates associated with the welding power supply, and wherein the remote control circuitry is further to receive the data in the signals from the transceiver, identify a welding power supply software update of the one or more software updates within the data, and control the transceiver to transmit a second wireless signal comprising the welding power supply software update to the welding power supply.

In some examples, a memory storage device is included in the remote control circuitry which stores the data corresponding to the one or more diagnostic parameters in the memory storage device, receives an input from the remote computing system to transmit the data, and control the transceiver to transmit the data to the remote computing system.

In some examples, the one or more diagnostic parameters comprises one or more of a voltage, a current, a power value, an engine status, or a welding process. In some examples, the remote control circuitry further comprises a network interface to connect to a remote computing system via one or more of LAN, WAN, Bluetooth, Wi-Fi, or cellular networks. In some examples, the remote control circuitry is further configured to transmit data from the memory storage to the remote computing system in real-time.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, the terms “first” and “second” may be used to enumerate different components or elements of the same type, and do not necessarily imply any particular order.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “memory” includes volatile and non-volatile memory devices and/or other storage device.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, cutting process, and/or any other type of welding process.

As used herein, the term “welding program” or “weld program” includes at least a set of welding parameters for controlling a weld. A welding program may further include other software, algorithms, processes, or other logic to control one or more welding-type devices to perform a weld.

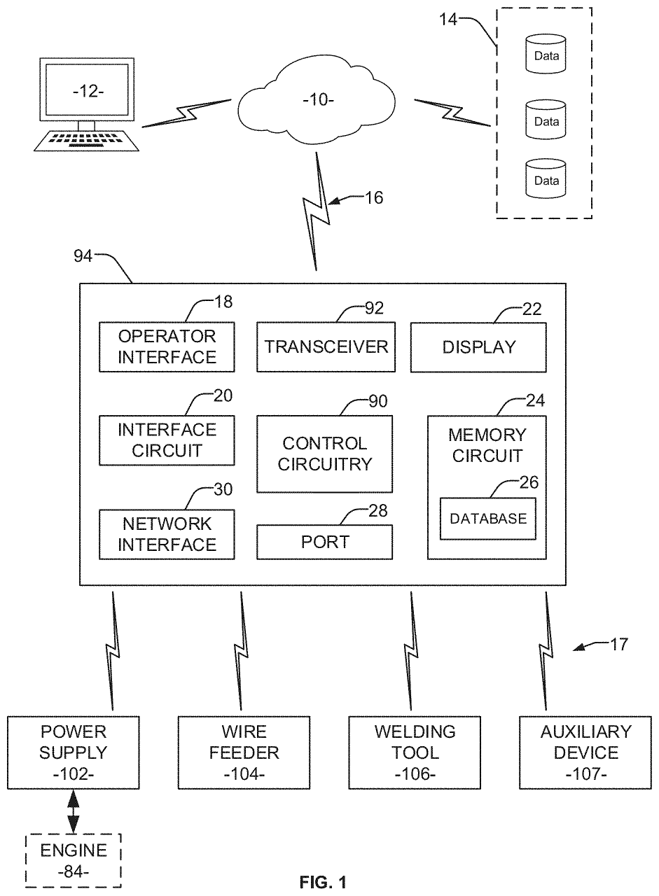

FIG. 1 is a schematic diagram of an example welding system and a remote device 94. The remote device 94 includes a control circuitry 90 to coordinate and/or control communications with various components of the welding system (e.g., a welding power supply 102, a wire feeder 104, a welding tool 106, an auxiliary device 107, etc.) via one or more communications links 17, and one or more remote assets (e.g., a remote computer device 12, one or more databases 14, etc.) via communications link 16 to a network 10. For example, the control circuitry 90 of the remote device 94 further includes a network interface 30 to connect to the transceiver 92, the components of the welding system, and/or the remote computer system 12 via one or more of network types or communications protocols, including by not limited to LAN, WAN, Bluetooth, Wi-Fi, or cellular networks. The remote device 94 further includes a memory storage devices or circuits 24, which may include one or more databases 26 or lists, and/or diagnostic parameter information.

In some examples, the remote device 94 is a portable handheld wireless device, such as a smartphone, remote computer, tablet computer, dongle, accessory, or other device suitable to analyze, receive and/or transmit data wirelessly and/or via wired communications.

In examples, the remote operator interface 18 or the welding user interfaces comprises one or more of a button, a membrane panel switch, or a graphical user interface to provide input to control the welding system. The operator interface 18 may include a display 22, or the display 22 may be separate from the operator interface 18.

In some examples, signals communicated between the remote computer system 12 and the components of the welding system are encoded with information to uniquely identify the respective system. In some examples, the signals are transmitted with one or more transmission characteristics to uniquely identify the respective system. The example system may include other components not specifically discussed herein.

In some examples, the remote computer system 12 and the components of the welding system are controlled to transfer diagnostic information at periodic intervals, in response to an adjustment to the one or more monitored diagnostic parameters, in response to a user input, or a combination thereof.

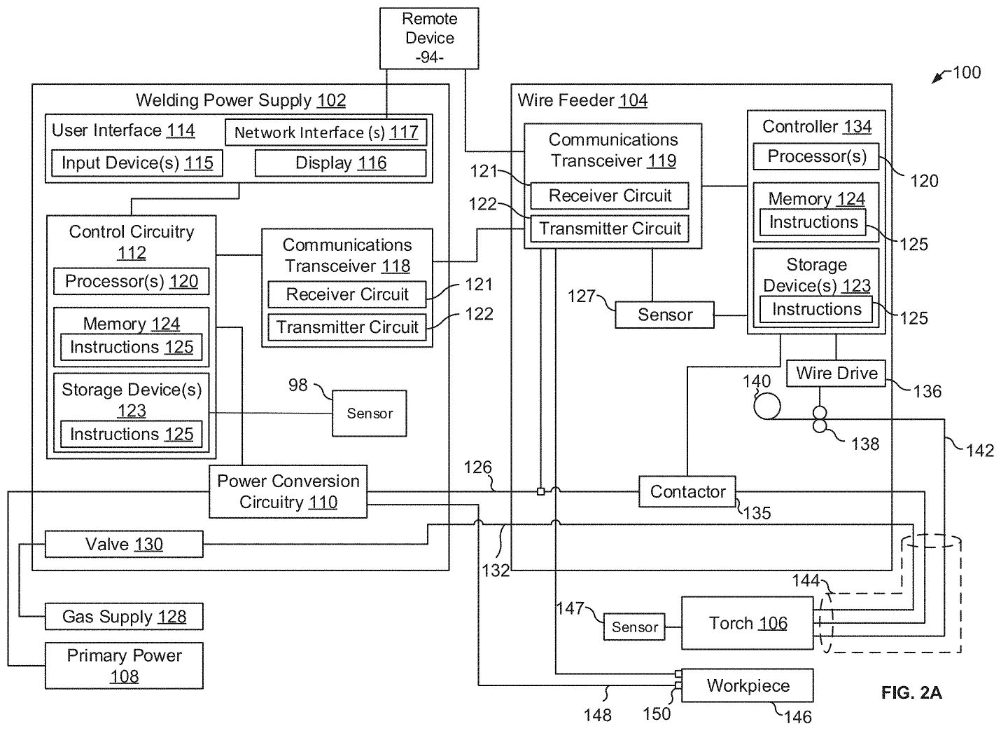

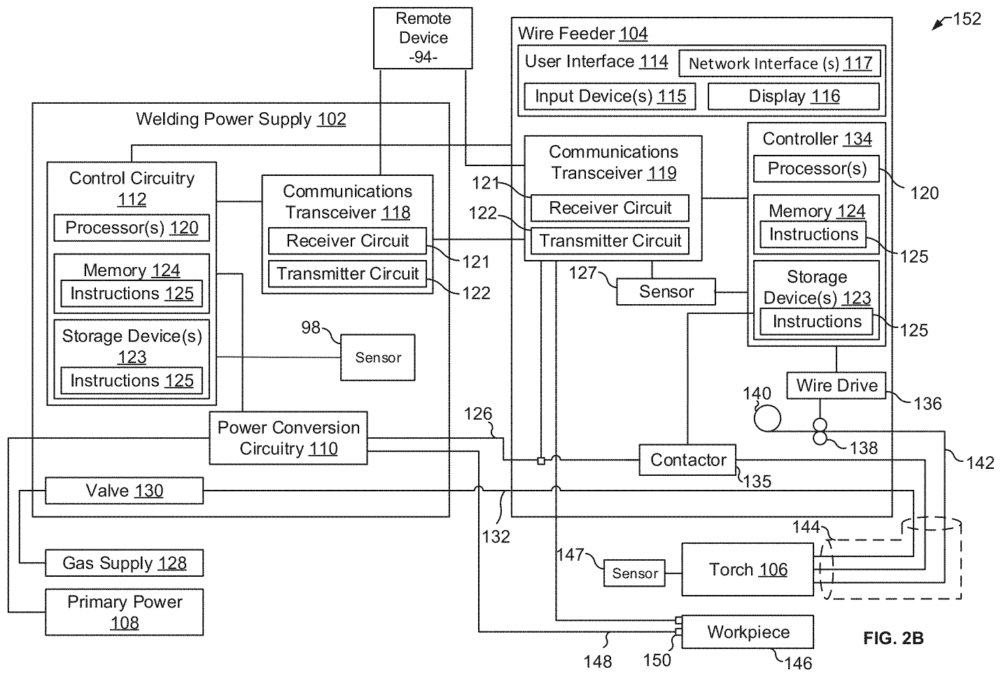

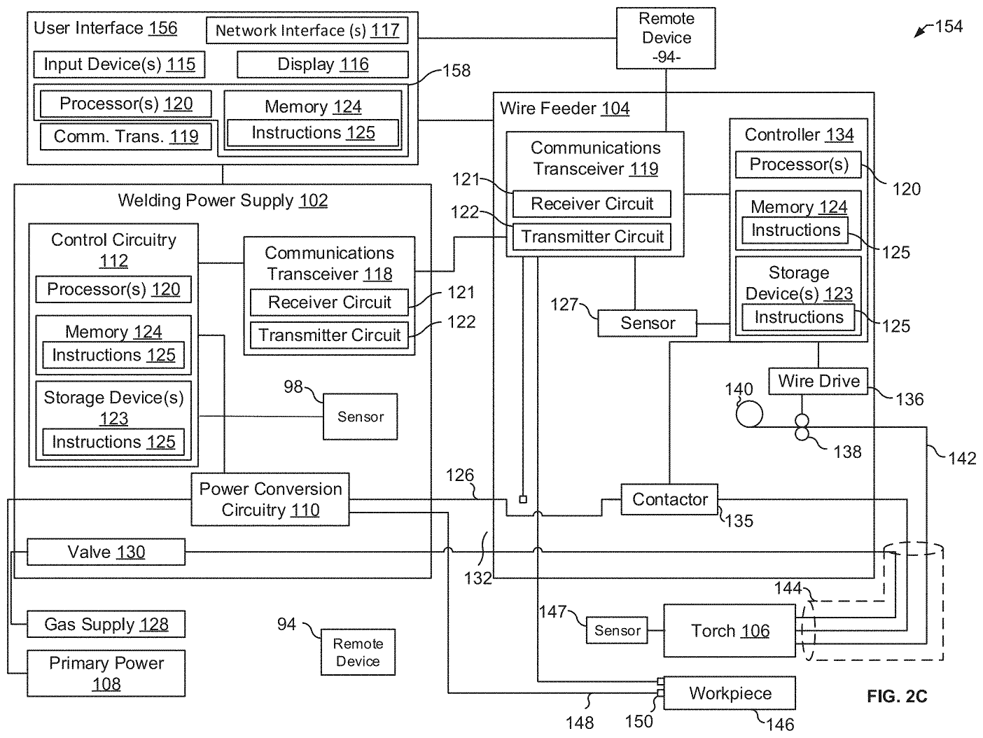

By use of the remote device 94, an operator can receive data (e.g., diagnostic information) and alerts from the network 10 and or the welding system components 102, 104, 106, 107 (see FIG. 2A-2C) via one or more of communications transceivers 92 and/or interfaces (e.g., shown in FIG. 1B-2C). Additionally, the remote device 94 may receive and/or display a status and/or diagnostic information of the welding system components 102, 104, 106, 107 (e.g., on the display and/or via audible and/or haptic feedback).

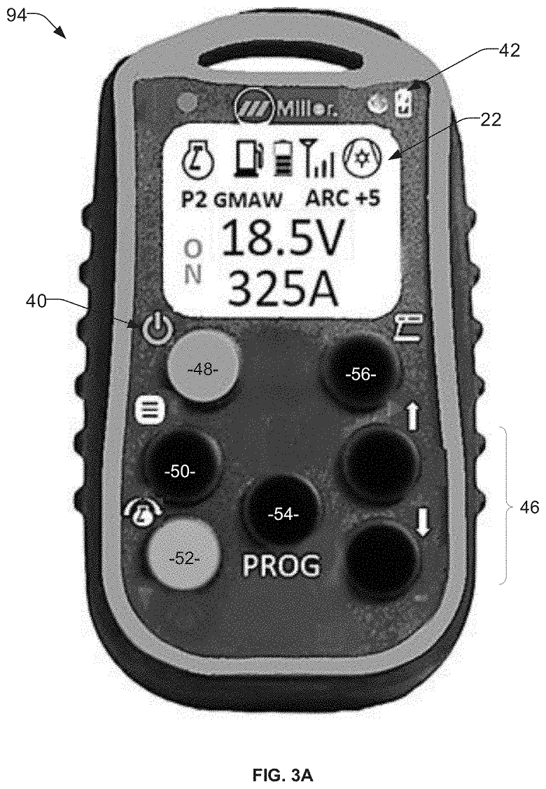

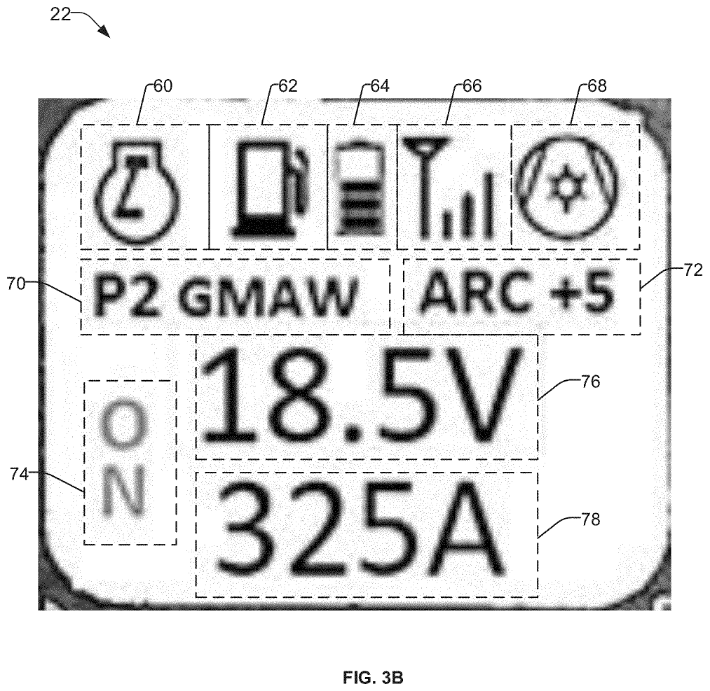

For example, the remote device 94 can include a display (e.g., a graphical user interface, and/or a touchscreen), as well as one or more input devices (e.g., a button, knob, switch, and/or a touchscreen, as illustrated in FIG. 3A).

In some examples, a remote device 94 is configured to control one or more operations of the welding system components 102, 104, 106, 107.

In some examples, the control circuitry 90 controls the multiple control sources to update systems and displays to harmonize commands and/or data that originated at another source. For instance, diagnostic information (e.g., a wire feed speed, amount of remaining or consumed wire) may be transmitted from the wire feeder 104 to the remote device 94, which may in turn be transmitted to the welding power supply 102. The welding power supply 102 may then display such diagnostic information from the wire feeder 104, and/or incorporate such diagnostic information into calculations on supplying power.

In some examples, a welding power supply 102 receives power from an engine driven power system 84, which is optionally in communication with remote device 94 for monitoring and/or control. For example, a welding power supply 102 is provided to control and deliver power to one or more welding tools (e.g., a welding type torch 106), accessories or auxiliary devices (e.g., a wire feeder 104). Thus, the control circuitry 90 receives the signals, which includes data corresponding to one or more diagnostic parameters associated with the engine driven system 84 (e.g., voltage, a current, a power value, an engine status, a welding process, etc.).

In some examples, the control circuitry 90 generates an alert when an operating parameter value of the one or more operating parameters of a component of the welding system exceeds a predetermined range of values, such as an audible, visual, and/or haptic indicator. The alert may be provided to the remote device 94 (e.g., from the power supply 102) for display on the user interface 18 and/or transmitted to the remote control system 12 (e.g., a remote computer, processor, smartphone, etc.).

In some disclosed examples, the remote computer system 12 may provide data to the remote device 94 for transmission to one or more components of the welding system. For example, when a software update becomes available, the remote computer system 12 can push the update to the welding system components via the remote device 94. In some examples, the operator can utilize a port 28 to transmit updates to or receive updates from the welding system components. Transmission of data (e.g., via the transceiver 92, network interface 30, interface circuitry 20, and/or port 28) may be communicate by a variety of hardware and/or protocols, such as via serial communications (e.g., full-duplex RS-232 or RS-422, or half-duplex RS-485), network communications (e.g., Ethernet, PROFIBUS, IEEE 802.1X wireless communications, etc.), parallel communications, and/or any other type of communications techniques.

In some examples, the remote device 94 is connected to the welding power supply 102, wire feeder 104, torch 106, the auxiliary device 107, or the remote computer system 12 via the input port. Once connected, power or information is transmitted to or received from the welding power supply 102, wire feeder 104, torch 106, the auxiliary device 107, or the remote computer system 12. For example, the remote device 94 may include a rechargeable energy storage device, which is rechargeable by a power output of the welding power supply, the auxiliary device, or the remote computer system.

FIG. 2A is a block diagram of an example welding system 100, which includes a welding-type power supply 102 containing power circuitry 110 and control circuitry 112 described with respect to FIG. 1. As shown in FIG. 2A, the example welding system 100 also includes the wire feeder 104, and the welding torch 106. The remote device 94 is communicably coupled to the welding system 100, as well as the other components of power system, via one or more of the transceiver 92, interface circuitry 20, and/or port 28. The welding system 100 powers, controls, and supplies consumables to a welding application. Although illustrated with respect to a welding type power supply 102 and welding wire feeder 104, the remote device 94 may implement the monitoring and/or control processes described herein in a variety of settings (e.g., such as industrial environments, a home or office networked environments, a network of vehicles or other machinery, etc.).

In some examples, the power supply 102 receives power from engine 84 (e.g., via a generator) and directly supplies input power to the welding torch 106 via power conversion circuitry 112. The welding torch 106 may be a torch configured for shielded metal arc welding (SMAW, or stick welding), gas tungsten arc welding (GTAW, or tungsten inert gas (TIG)) welding, gas metal arc welding (GMAW), flux cored arc welding (FCAW), based on the desired welding application. In the illustrated example, the power supply 102 is configured to supply power to the wire feeder 104, and the wire feeder 104 may be configured to route the input power to the welding torch 106. In addition to supplying an input power, the wire feeder 104 may supply a filler metal to the welding torch 106 for various welding applications (e.g., GMAW welding, flux core arc welding (FCAW)). While the example system 100 of FIG. 2A includes a wire feeder 104 (e.g., for GMAW or FCAW welding), the wire feeder 104 may be replaced by any other type of remote accessory device, such as a stick welding and/or GTAW welding remote control interface that provides stick and/or GTAW welding

The power supply 102 receives primary power 108 (e.g., from an engine and/or generator, mains power, energy storage system, etc.), conditions the primary power, and provides an output power to one or more welding devices in accordance with demands of the system 100. The power supply 102 includes the power conversion circuitry 110, which may include transformers, rectifiers, switches, and so forth, capable of converting the AC input power to AC and/or DC output power as dictated by the demands of the system 100 (e.g., particular welding processes and regimes). The power conversion circuitry 110 converts input power (e.g., the primary power 108) to welding-type power based on a weld voltage setpoint and outputs the welding-type power via a weld circuit.

In some examples, the power conversion circuitry 110 is configured to convert the primary power 108 to both welding-type power and auxiliary power outputs. However, in other examples, the power conversion circuitry 110 is adapted to convert primary power only to a weld power output, and a separate auxiliary converter 111 is provided to convert primary power to auxiliary power. In some other examples, the power supply 102 receives a converted auxiliary power output directly from a wall outlet. Any suitable power conversion system or mechanism may be employed by the power supply 102 to generate and supply both weld and auxiliary power.

The control circuitry 112 controls the operation of the power supply 102 and may control the operation of the primary power source in some examples. The power supply 102 also includes one or more interfaces, such as a user interface 114 and network interface 117. The control circuitry 112 receives input from the user interface 114, through which a user may control one or more components (including the engine 84 and/or generator of a primary power system), and or choose a process and/or input desired parameters for a welding output (e.g., voltages, currents, particular pulsed or non-pulsed welding regimes, and so forth). The user interface 114 may receive inputs using one or more input devices 115, such as via a keypad, keyboard, physical buttons, a touch screen (e.g., software buttons), a voice activation system, a wireless device, remote device 94, etc. Furthermore, the control circuitry 112 controls operating parameters based on input by the user as well as based on other operating parameters. Specifically, the user interface 114 may include a display 116 for presenting, showing, or indicating, information to an operator. In some examples, the control circuitry 112 receives an input provided via remote device 94 via network interface 117. In this manner, the control circuitry 112 can provide data regarding operation of the primary power system (including alerts associated with operation of an associated engine) and/or receive diagnostic information and/or commands from the remote device 94 (e.g., starting the engine 84).

The control circuitry 112 may also include interface circuitry for communicating data with the remote device 94 and other devices in the system 100, such as the wire feeder 104. For example, in some situations, the power supply 102 wirelessly communicates with other components within the welding system 100. Further, in some situations, the power supply 102 communicates with other welding devices using a wired connection, such as by using a network interface controller (NIC) to communicate data via a network (e.g., ETHERNET, 10baseT, 10base100, etc.). In the example of FIG. 2A, the control circuitry 112 communicates with the wire feeder 104 via the weld circuit via a communications transceiver 118, as described below.

The control circuitry 112 includes at least one controller or processor 120 that controls the operations of the power supply 102. The control circuitry 112 receives and processes multiple inputs associated with the performance and demands of the system 100. The processor 120 may include one or more microprocessors, such as one or more “general-purpose” microprocessors, one or more special-purpose microprocessors and/or ASICS, and/or any other type of processing device. For example, the processor 120 may include one or more digital signal processors (DSPs).

The example control circuitry 112 includes one or more storage device(s) 123 and one or more memory device(s) 124. The storage device(s) 123 (e.g., nonvolatile storage) may include ROM, flash memory, a hard drive, and/or any other suitable optical, magnetic, and/or solid-state storage medium, and/or a combination thereof. The storage device 123 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, deposition rate, wire feed speed, puddle fluidity, and so forth.

The memory device 124 (and/or the memory storage device 24) may include a volatile memory, such as random access memory (RAM), and/or a nonvolatile memory, such as read-only memory (ROM). The memory device 124 and/or the storage device(s) 123 may store a variety of information and may be used for various purposes. For example, the memory device 124 and/or the storage device(s) 123 may store processor executable instructions 125 (e.g., firmware or software) for the processor 120 to execute. In addition, one or more control regimes for various welding processes, along with associated settings and parameters, may be stored in the storage device 123 and/or memory device 124, along with code configured to provide a specific output (e.g., initiate wire feed, enable gas flow, capture welding related data, detect short circuit parameters, determine amount of spatter) during operation. One or more lists or lookup tables may be provided, and/or network connections to various databases available to inform decision-making, such as to access preferred welding parameters, to store updated welding parameter settings, etc.

In some examples, the control circuitry 90 stores one or more lists associated with values associated with one or more diagnostic parameters associated with the welding system including engine status, hours of operation, oil level, current, voltage, power and/or other values that correlate the characteristics to one or more indicia (e.g., an icon, text, a graphic, an animation, etc.), such as in memory 24 and/or 124. The control circuitry 90 can access the one or more lists in response to an input (e.g., a transmission from a component of the welding system; from an operator input; etc.). An input with data corresponding to the one or more diagnostic parameters can be provided via user interface 114 and/or from interface 19 of remote device 94 via transceiver 92.

In some examples, the control circuitry 90 is configured to store the data in a memory storage device (e.g., memory 24, 124). In some examples, the data is analyzed to determine a parameter value associated with the received diagnostic parameters. The parameter values are compared to a list of parameter icons that correlates parameter values to a plurality of icons. The control circuitry 90 then determines a parameter icon corresponding to the diagnostic parameters, and controls display 22 to display icon data on the remote device 94.

In some examples, the control circuitry 90 is in communication with a sensor 98 to receive, analyze and/or measure signal characteristics, such as associated with the one or more welding parameters. Thus, changes in output, operating parameters, even those that are uncommanded, are updated on the multiple sources. Each component of the welding system may include a similar sensor configured to collect and/or transmit operating parameters of the respective component. Accordingly, sensor data can be directly transmitted to the remote device 94 without processing at the respective component (e.g., welding power supply 102, wire feeder 104, welding torch 106, auxiliary device 107, etc.).

In some examples, the welding power flows from the power conversion circuitry 110 through a weld cable 126 to the wire feeder 104 and the welding torch 106. The example weld cable 126 is attachable and detachable from weld studs at each of the power supply 102 and the wire feeder 104 (e.g., to enable ease of replacement of the weld cable 126 in case of wear or damage).

In some examples, the remote device 94 includes remote control circuitry operable to transmit information to and receive information from an auxiliary device, such as wire feeder 104. The wire feeder 102 responds with diagnostic information, and the remote device 94 can store (in memory) and/or display the diagnostic information on the remote user interface.

In some examples, the remote device 94 serves as a link between the components of the welding system and/or the remote computing system. Thus, the remote device 94 can receive commands and/or data from one or more of the welding system components (or the remote computing system), and transmit the commands and/or data from the one or more of the welding system components (or the remote computing system) to the remote computing system (or the one or more of the welding system components).

Furthermore, in some examples, in addition to transmission via the remote device 94, welding data may be provided with the weld cable 126 such that welding power and weld data are provided and transmitted together over the weld cable 126. The communications transceiver 118 is communicatively coupled to the weld cable 126 to communicate (e.g., send/receive) data over the weld cable 126. The communications transceiver 118 may be implemented using serial communications (e.g., full-duplex RS-232 or RS-422, or half-duplex RS-485), network communications (e.g., Ethernet, PROFIBUS, IEEE 802.1X wireless communications, etc.), parallel communications, and/or any other type of communications techniques. In some examples, the communications transceiver 118 may implement communications over the weld cable 126.

The example communications transceiver 118 includes a receiver circuit 121 and a transmitter circuit 122. Generally, the receiver circuit 121 receives data transmitted by the wire feeder 104 via the weld cable 126 and the transmitter circuit 122 transmits data to the wire feeder 104 via the weld cable 126. The communications transceiver 118 enables remote configuration of the power supply 102 from the location of the wire feeder 104, and/or command and/or control of the wire feed speed output by the wire feeder 104 and/or the weld power (e.g., voltage, current) output by the power supply 102. In some examples, the communications are transmitted via a dedicated cable between components and/or wireless communications channels, as well as other suitable communications devices and/or techniques.

The example wire feeder 104 also includes a communications transceiver 119, which may be similar or identical in construction and/or function as the communications transceiver 118. While communication with the remote device 94 is disclosed, additionally communication over a communications cable is provided as illustrated in FIG. 2A.

In some examples, a gas supply 128 provides shielding gases, such as argon, helium, carbon dioxide, and so forth, depending upon the welding application. The shielding gas flows to a valve 130, which controls the flow of gas, and if desired, may be selected to allow for modulating or regulating the amount of gas supplied to a welding application. The valve 130 may be opened, closed, or otherwise operated by the control circuitry 112 to enable, inhibit, or control gas flow (e.g., shielding gas) through the valve 130. Shielding gas exits the valve 130 and flows through a cable 132 (which in some implementations may be packaged with the welding power output) to the wire feeder 104, which provides the shielding gas to the welding application. In some examples, the welding system 100 does not include the gas supply 128, the valve 130, and/or the cable 132.

In some examples, the wire feeder 104 uses the welding power to power the various components in the wire feeder 104, such as to power a wire feeder controller 134. As noted above, the weld cable 126 may be configured to provide or supply the welding power. The power supply 102 may also communicate with a communications transceiver 119 of the wire feeder 104 using the weld cable 126 and the communications transceiver 118 disposed within the power supply 102, in addition to relay transmission via the remote device 94. In some examples, the communications transceiver 119 is substantially similar to the communications transceiver 118 of the power supply 102. The wire feeder controller 134 controls the operations of the wire feeder 104. In some examples, the wire feeder 104 uses the wire feeder controller 134 to detect whether the wire feeder 104 is in communication with the power supply 102 and to detect a current welding process of the power supply 102 if the wire feeder 104 is in communication with the power supply 102.

In examples, the power supply 102 delivers a power output directly to torch 106 without employing any contactor. In such an example, power regulation is governed by the control circuitry 112 and/or the power conversion circuitry 110. In some examples, a contactor 135 (e.g., high amperage relay) is employed and controlled by the wire feeder controller 134 and configured to enable or inhibit welding power to continue to flow to the weld cable 126 for the welding application. In some examples, the contactor 135 is an electromechanical device. However, the contactor 135 may be any other suitable device, such as a solid-state device. The wire feeder 104 includes a wire drive 136 that receives control signals from the wire feeder controller 134 to drive rollers 138 that rotate to pull wire off a spool 140 of wire. The wire is provided to the welding application through a torch cable 142. Likewise, the wire feeder 104 may provide the shielding gas from the cable 132 through the cable 142. The electrode wire, the shield gas, and the power from the weld cable 126 are bundled together in a single torch cable 144 and/or individually provided to the welding torch 106. In some examples, the contactor 135 is omitted and output or welding-type power is initiated and stopped by the power supply 102 without employing a contactor 135. In some examples, one or more sensors 127 are included with or connected to in the wire feeder 104 to monitor one or more welding parameters (e.g., power, voltage, current, wire feed speed, etc.) to inform the controller 134 during the welding process. In some examples, one or more sensors are included in the welding power supply 102.

The welding torch 106 delivers the wire, welding power, and/or shielding gas for a welding application. The welding torch 106 is used to establish a welding arc between the welding torch 106 and a workpiece 146. A work cable 148 couples the workpiece 146 to the power supply 102 (e.g., to the power conversion circuitry 110) to provide a return path for the weld current (e.g., as part of the weld circuit). The example work cable 148 is attachable and/or detachable from the power supply 102 for ease of replacement of the work cable 148. The work cable 148 may be terminated with a clamp 150 (or another power connecting device), which couples the power supply 102 to the workpiece 146. In some examples, one or more sensors 147 are included with or connected to the welding torch 106 to monitor one or more welding parameters (e.g., power, voltage, current, wire feed speed, etc.) to inform the controller 134 and/or 112 during the welding process. Although illustrated with the torch 106 (e.g., a welding tool, as described herein) connecting through wire feeder 104, in some examples, the welding tool can connect directly to the welding power supply 102. For instance, a gouging and/or cutting tool may connect directly to studs or another power outlet of the welding power supply 102. In some examples, a wire feeder is integrated with the power supply, and studs or other power outlets are provided on the housing of such an integrated enclosure.

FIG. 2B is a schematic diagram of another example welding system 152 in which the wire feeder 104 includes the user interface 114 in addition or as an alternative to the user interface on the welding power supply 102. In the example of FIG. 2B, the control circuitry 134 of the wire feeder 104 implements the determinations of the welding program and welding parameters which are described with reference to the control circuitry 112 of FIG. 2A.

FIG. 2C is a schematic diagram of another example welding system 154 including a separate user interface 156. The user interface 156 is a separate device, and may be connected to the welding power supply 102 and/or to the wire feeder 104 to provide commands and/or control information. The example user interface 156 includes the input devices 115 and the display 116, and includes control circuitry 158. The example control circuitry 158 includes the processor(s) 120 and the memory 124 storing the instructions 125. The example user interface 156 further includes a communications transceiver 119 to enable communications between the user interface 156 and the welding power supply 102 and/or the wire feeder.

Although FIGS. 2A-2C are illustrated as having a user interface (114, 156) incorporated with a particular system, the illustration is exemplary such that one or more of the interfaces disclosed herein as well as additional user interfaces may be incorporated in one or more of the example welding systems disclosed herein. Furthermore, although power supply 102 and wire feeder 104 are illustrated as independent units, in some examples, the power supply and wire feeder can be housed in a single enclosure or otherwise integrated. Additionally or alternatively, a single controller, control circuitry, and/or interface can control operation of the engine 84, the power supply 102, and wire feeder 104, in some examples.

FIG. 3A illustrates a detail view of the remote device 94. As shown, the remote device 94 provides one or more remote user interfaces, such as a battery indicator 42, a remote display 22, and one or more input devices 46-56 (e.g., a button, knob, switch, and/or a touchscreen). The remote device 94 may display indicia corresponding to one or more diagnostic parameters on the remote display 22, and/or provide an alert thereto (e.g., audible, haptic, visual). In some examples, the control circuitry 90, via one or more of the transceiver 92, network interface 30 and/or interface circuitry 20, can receive diagnostic information from one or more components of the welding system and/or the remote computer system 12. The diagnostic information can be stored in memory device 24 and/or communicated with another component and/or remote resource via the network 10.

In some examples, the input devices 46-56 can allow a user to toggle through a selection via buttons 46. A selection can be made to view diagnostic information corresponding to various components of the welding system via one or more input devices 46-56. In some examples, the operator may scroll through a list of commands for various components, such as the engine 84 via input 52, welding process via input device 56, a welding sequence program via input device 54, power via input device 48, and/or call a menu via input device 50. Thus, the remote device 94 is operable to receive inputs from the input devices 46-56 associated with one or more diagnostic parameters, commands, transmit signals comprising data corresponding to the inputs to the control circuitry 90 (e.g., via a remote control circuit, not shown), and to have an indicia on the remote display 22 change to reflect the received information, as disclosed herein.

FIG. 3B illustrates a detail view of the remote display 22. As shown, the remote display 22 includes multiple regions, each to display one or more indicia corresponding to one or more diagnostic parameters. In some examples, each region displays a single indicia, which may change color, flash, appear, disappear, or provide some other visual cue to provide information to the operator. In some examples, which indicia and/or which type of indicia is dynamic, such that the operator may select a particular indicia to be displayed in a predetermined region, and/or one or more events can trigger a transition from one indicia to another within a given region (e.g., when a battery is out of energy, a battery icon can be replaced with a lightning bolt indicating the battery is being charged).

In the example of FIG. 3B, the regions can include one or more of an icon, text, a graphic, or an animation. As shown, region 60 provides an engine icon, region 62 provides a fuel gauge icon, region 64 provides a battery level icon, region 66 provides a wireless signal icon, region 68 illustrates an air compressor icon, region 70 provides text indicative of a welding process, region 72 provides text indicative of an arc length, region 74 provides text indicative of a power on/off status, region 76 provides an output voltage icon, and region 78 provides an output current icon. As disclosed herein, each region and/or indicia can provide information associated with one or more diagnostic parameters. Each indicia can be changed in response to a received one or more of the diagnostic parameters (an adjusted value) and/or a status change (a change in wireless signal strength). Additional or alternative indicia can correspond to engine run time, wire feed speed, welding sequence, material type, material thickness, for instance. Additionally, an indicia can provide information as to which of the multiple control sources is operating in dedicated control mode and which is operating in a supervisory or display only mode.

For example, the remote user interface can display one or more indicia of a diagnostic parameter of the one or more diagnostic parameters associated with the welding system. The remote control circuitry 90 can identify a first value of a first diagnostic parameter, received via data within one or more wireless signals, of the one or more diagnostic parameters in the corresponding data. The remote control circuitry 90 can determine a first indicia of the one or more indicia corresponding to the first value; and control the remote user interface 18 to display the first indicia (e.g. on display 22).

In some examples, the one or more indicia includes one or more of an icon, text, a graphic, an animation, corresponding to a characteristic of the welding system, which can be displayed in one or a plurality of regions of the remote user interface, each region to display an indicia of the one or more indicia.

Additionally or alternatively, the remote device 94 can receive, store, and/or relay data corresponding to software update(s) for the one or more components of the welding system. For example, the remote computer system 12 may query the remote device 94 for software versions on linked components. The remote device 94 can then in turn query the components for the current version of software. The software information can be transmitted to the remote computer system 12 for analysis, and/or compared against a list of software versions on the memory device 24. If an update is available, the remote device 94 transmits the software to the respective component for upgrade. In some examples, the software updates are pushed from the remote computer system 12 to the remote device 94 when a communications link is available, the software is stored in memory 24, then transmitted to the various components of the welding system when a link is established. This can be done at a convenient time, such as during a maintenance period, at start up, powering down, or other suitable work stoppage.

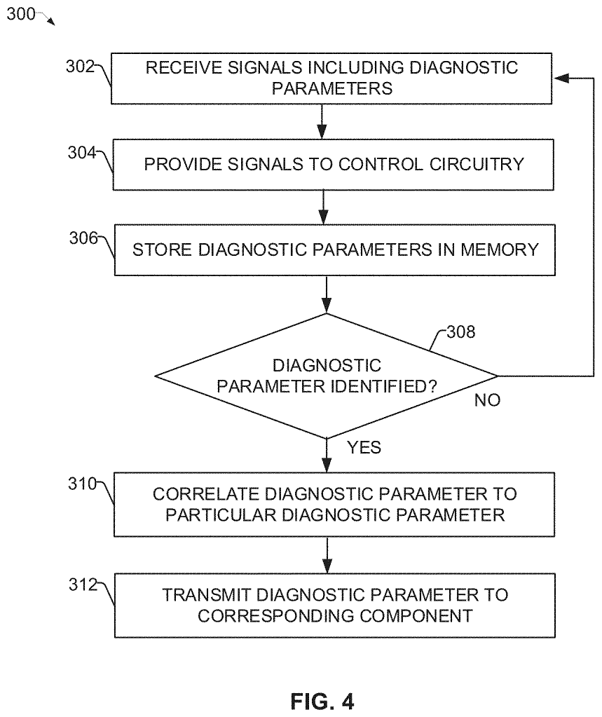

FIG. 4 provides a flowchart representative of example machine readable instructions 300 which may be executed by the example remote device 94 of FIG. 1 for monitoring or controlling a welding power supply. The example instructions 300 may be stored in the storage device(s) 24, 123 and/or 124 and executed by the processor(s) of the control circuitry 90, 112. The example instructions 300 are described below with reference to the systems of FIGS. 1 through 2C.

In block 302, the remote device receives one or more wireless signals from one or more components of the welding system (e.g., the welding power supply 102, the wire feeder 104, the welding torch 106, the auxiliary device 107) via a transceiver (e.g., transceiver 92). For example, the signals include data corresponding to one or more diagnostic parameters associated with the welding power supply (e.g., an engine time usage, fuel consumption, temperature, wire consumption, battery charge status, wire feeder roller time usage, contact tip time usage, oil level, or software version).

In block 304, the data from the signals is received at a remote control circuitry (e.g., control circuitry 90). For instance, the diagnostic parameters from the component(s) are received via a remote user interface (e.g., operator interface 18). In some examples, the one or more signals are transmitted via a welding transceiver directly from one or more sensors corresponding to one or more sub-systems of the welding system. For instance, the one or more signals can include raw data from the one or more sensors.

In block 306, the diagnostic parameters are stored on the memory storage device. In block 308, the remote control circuitry identifies a diagnostic parameter of the one or more diagnostic parameters within the data. In other words, the remote control circuitry correlates a diagnostic parameter with a corresponding component. This can be done for each signal, regardless of the component transmitting the signal.

In block 310, the diagnostic parameters are correlated to a particular diagnostic parameter. For instance, data from the signal may be analyzed for information associated with the diagnostic parameter, and/or a list may be accessed which correlates diagnostic parameters with data associated with the particular diagnostic parameter (e.g., parameter type, value, associated indicia,

In block 312, the transceiver transmits another signal comprising the diagnostic parameter and/or information associated with the particular diagnostic parameter to a remote computer system (e.g., the remote computer system 12) from the memory storage. In some examples, the data transfer is in real-time. In some examples, transfer of data between the remote computer system and the component(s) is initiated at periodic intervals, in response to a user input, or a combination of both. In some examples, the diagnostic parameter are displayed on one or more regions of the remote user interface.

In some examples, the diagnostic information received at the remote device is from a first component (e.g., one of the welding power supply or the auxiliary device). As provided in block 312, the diagnostic information from the first component (e.g., the welding power supply) can be transmitted to a second component (e.g., the auxiliary device) (for display, incorporation into an output algorithm, weld schedule, transmission to a networked remote asset, etc.). In some examples, additional data, such as control information, can also be received.

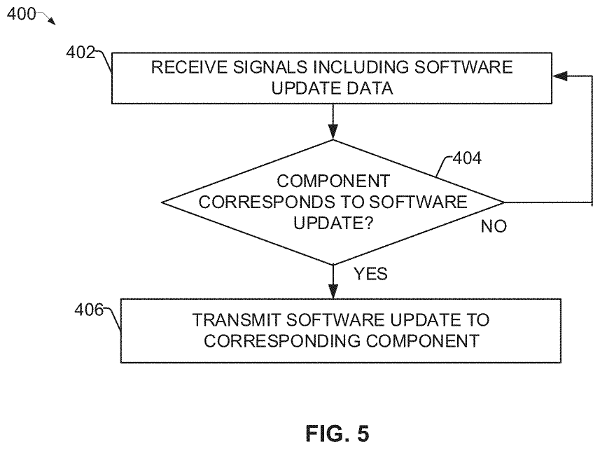

FIG. 5 provides a flowchart representative of example machine readable instructions 400 which may be executed by the example remote device 94 of FIG. 1. The example instructions 400 may be stored in the storage device(s) 24, 123 and/or 124 and executed by the example remote device 94 of FIG. 1 for monitoring or controlling a welding power supply by the processor(s) of the control circuitry 90, 112. The example instructions 400 are described below with reference to the systems of FIGS. 1 through 2C.

In block 402, one or more signals are received at the remote device (e.g., via the transceiver 92) from the remote computer system, wherein the signals include data corresponding to one or more software updates associated with one or more components of the welding system (e.g., the welding power supply 102, wire feeder 104, welding torch 106, auxiliary device 107, engine 84, etc.).

In some examples, the one or more signals are received (via the transceiver) from one or more components (e.g., the welding power supply, wire feeder, auxiliary device, torch, etc.), the signals including data corresponding to one or more software updates associated with another component.

In block 404, the component corresponding to the software update of the one or more software updates is identified from the data (e.g., via the control circuitry 90). For example, the software update may include data that identifies a particular component or type of component to receive the software update. In some examples, the software update corresponds to more than one component, and is to be provided to each corresponding component.

In block 406, a wireless signal comprising the software update is generated and transmitted to the corresponding component via the remote control circuitry.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power supply with a program or other code that, when being loaded and executed, controls the welding power supply such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine-readable storage media and to exclude propagating signals.

The control circuitry may identify welding conditions of a given weld and automatically find the optimum value of one or more welding parameters for the welding conditions. An example control circuit implementation may be a microcontroller, a field programmable logic circuit and/or any other control or logic circuit capable of executing instructions that executes weld control software. The control circuit could also be implemented in analog circuits and/or a combination of digital and analog circuitry. Examples are described herein with reference to various types of welders, but may be used or modified for use in any type of high frequency switching power source.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A remote device for monitoring or controlling a welding power supply comprising:
a transceiver configured to receive one or more wireless signals from the welding power supply, wherein the signals include data corresponding to one or more diagnostic parameters associated with the welding power supply; and
a remote control circuitry configured to:
receive the data from the signals from the transceiver;
identify a diagnostic parameter of the one or more diagnostic parameters within the data; and
control the transceiver to transmit another signal comprising the diagnostic parameter to a remote computer system.

2. The remote device as defined in claim 1, further comprising a remote user interface, wherein the remote control circuitry is further configured to:
receive diagnostic parameters from the welding power supply or an auxiliary device; and
display the diagnostic parameter on one or more regions of the remote user interface.

3. The remote device as defined in claim 1, further comprising a memory storage device, the remote control circuitry is further configured to store the diagnostic parameters on the memory storage device.

4. The remote device as defined in claim 3, wherein the remote control circuitry is further configured to transmit data from the memory storage to a remote computing system in real-time.

5. The remote device as defined in claim 1, wherein the one or more signals are transmitted via a welding transceiver directly from one or more sensors corresponding to one or more sub-systems of the welding system, the one or more signals including raw data from the one or more sensors.

6. The remote device as defined in claim 1, further comprising an input port to receive a cable to connect to the welding power supply, an auxiliary device, or a remote computer system, the input port to transmit power or information to or receive power or information from the welding power supply, the auxiliary device, or the remote computer system.

7. The remote device as defined in claim 6, further comprising a rechargeable energy storage device, the rechargeable energy storage device being rechargeable by a power output of the welding power supply, the auxiliary device, or the remote computer system.

8. The remote device as defined in claim 1, wherein the remote control circuitry is further configured to initiate transfer of data between the remote computer system and the welding power supply at periodic intervals, in response to a user input, or a combination of both.

9. The remote device as defined in claim 1, wherein the remote control circuitry is further configured to:
transmit information to and receive information from an auxiliary device;
receive diagnostic information from the auxiliary device; and
display the diagnostic information on one or more regions of a remote user interface.

10. The remote device as defined in claim 9, wherein the remote control circuitry is further configured to:
receive data from the welding power supply; and
transmit the data from the welding power supply to the auxiliary device.

11. The remote device as defined in claim 9, wherein the remote control circuitry is further configured to:
receive commands or data from the auxiliary device; and
transmit the commands or data from the auxiliary device to the welding system.

12. The remote device as defined in claim 1, wherein the one or more diagnostic parameters comprises one or more of an engine time usage, fuel consumption, temperature, wire consumption, battery charge status, wire feeder roller time usage, contact tip time usage, oil level, or software version.

13. A remote device for monitoring or controlling a welding power supply comprising:
a transceiver configured to receive one or more signals from a remote computer system, wherein the signals include data corresponding to one or more software updates associated with the welding power supply; and
a remote control circuitry configured to:
receive the data in the signals from the transceiver;
identify a welding power supply software update of the one or more software updates within the data; and
control the transceiver to transmit a wireless signal comprising the welding power supply software update to the welding power supply.

14. The remote device as defined in claim 13, wherein the transceiver further configured to receive one or more signals from the remote computer system that include data corresponding to one or more software updates associated with an auxiliary device, and wherein the remote control circuitry is further configured to:
receive the data in the signals from the transceiver;
identify an auxiliary device software update of the one or more software updates within the data; and
control the transceiver to transmit a wireless signal comprising the auxiliary device software update to the auxiliary device.

15. The remote device as defined in claim 13, wherein the transceiver is further configured to receive one or more wireless signals from the welding power supply that include data corresponding to one or more software updates associated with an auxiliary device, and wherein the remote control circuitry is further configured to:
receive the data in the signals from the transceiver;
identify an auxiliary device software update of the one or more software updates within the data; and
control the transceiver to transmit a second wireless signal comprising the auxiliary device software update to the auxiliary device.

16. The remote device as defined in claim 13, wherein the transceiver further configured to receive one or more wireless signals from an auxiliary device that include data corresponding to one or more software updates associated with the welding power supply, and wherein the remote control circuitry is further configured to:
receive the data in the signals from the transceiver;
identify a welding power supply software update of the one or more software updates within the data; and
control the transceiver to transmit a second wireless signal comprising the welding power supply software update to the welding power supply.

17. The remote device as defined in claim 13, further comprising a memory storage device, wherein the remote control circuitry is further configured to:
store the data corresponding to the one or more diagnostic parameters in the memory storage device;
receive an input from the remote computing system to transmit the data; and
control the transceiver to transmit the data to the remote computing system.

18. The remote device as defined in claim 13, wherein the one or more diagnostic parameters comprises one or more of a voltage, a current, a power value, an engine status, or a welding process.

19. The remote device as defined in claim 13, wherein the remote control circuitry further comprises a network interface to connect to a remote computing system via one or more of LAN, WAN, Bluetooth, Wi-Fi, or cellular networks.

20. The remote device as defined in claim 19, wherein the remote control circuitry is further configured to transmit data from the memory storage to the remote computing system in real-time.
